(19) United States
(12) Patent Application Publication
(10) Pub. No.: US 2019/0189023 A1
(43) Pub. Date: Jun. 20, 2019

(54) VIRTUAL REALITY TRAINING METHOD FOR PREVENTION OF BULLYING

(71) Applicant: Cantab Tecnología S. de R.L. de C.V., Monterrey (MX)

(72) Inventors: Pedro Eduardo Salinas Vela, Monterrey (MX); Bruno Ángel Caballero García León, CDMX (MX)

(73) Assignee: Cantab Tecnología S. de R.L. de C.V., Monterrey (MX)

(21) Appl. No.: 15/843,489

(22) Filed: Dec. 15, 2017

(51) Int. Cl. G09B 7/02; G09B 9/00; G09B 19/22

(52) U.S. Cl. CPC G09B 7/02; G09B 19/22; G09B 9/00

(57) ABSTRACT

The present invention refers to a virtual reality training method oriented for the prevention of harassment in schools. It seeks to lower the incidence of bullying in academic environments by recreating spaces such as classrooms and playgrounds, where users are presented with real school bullying situations experienced by children. The situations have scope for bullies, victims and bystanders of bullying situations. The training method is designed for middle school and junior high school students in the age rate between 11 to 15 years. The virtual reality training consists of 1 tutorial and 12 levels. It requires hardware (1) that consists in a specialized computer system (2), a virtual reality display (3) or other form of visual stimulation such as screens and sound system that allow the user to have a virtual reality experience, and video game controls (4). Physiological monitoring sensors (5) may be used if available. Each participant is assigned an ID number and a password, to keep track of their progress. The software has a cloud database used to store student files (7). This makes it possible to keep track of the students' progress, review students' answers in each level and identify who is susceptible to bullying, and generate business intelligence and relevant statistics for schools and parents. After implementation of the program, the user has developed behavioral skills to prevent and combat bullying and school harassment. This results in a favorable impact on bullying statistics, as there is a visible reduction in the number of cases.

### FIELD OF THE INVENTION

The present invention relates to a training method for bullying prevention through a virtual reality environment. The invention will be used particularly in school environments, as it is focused on students in both middle school and junior high.

### BACKGROUND OF THE INVENTION

Aggressions between peers in the academic context are not new. However, the interest in this behavior has increased considerably during the last decades, particularly in studying the phenomenon as something out of the ordinary due to the consequences it has brought to the victims of this modality of violence, such as various mood disorders, poor academic and social performance, and even an increasing number of suicides.

The first definition of bullying was given by the Scandinavian psychologist, Dan Olweus, in 1993, and is as follows: “ . . . the set of physical and/or verbal behaviors that a person (or group of people), in a hostile manner and abusing a real or fictitious power, directs against another individual (or individuals) in a repetitive and lasting way with the intention to cause him harm”. According to this definition—which is widely accepted by researchers—aggressive behaviors among equals can be termed bullying if the following criteria are met:
The existence of an interpersonal relationship characterized by an imbalance of real or superficial power or force between victim and bully.
The aggressive behavior is performed repetitively, estimating a minimum frequency of one time per week and a minimum duration of six months.
There is an intentional and proactive character of the aggression, due to the search for some social, material or personal benefit, without prior provocation.

In an acute situation of school violence, it is possible to find three types of protagonists: bullies, victims and bystanders who witness, participate or praise the aggressions. Several investigations show that all subjects involved in situations of school abuse, regardless of the role, are at greater risk of suffering psychosocial and psychopathological disorders during adolescence and adult life than those who were not involved.

At present, different methodologies and processes have been developed to combat bullying. Technology developments go from monitoring and detection systems in schools, to methods of prevention and training using software tools. The prior art search identified the U.S. Pat. No. 6,425,764B1 (2002)—“Virtual reality immersion therapy for treating psychological, psychiatric, medical, educational and self-help problems”, which describes a method for treating psychological, psychiatric or medical conditions using virtual reality environments. However, it does not prevent bullying. Additionally, it does not implicate the use of the same strategy or environment for every patent. Rather, it allows patients the freedom to pick up objects and move them around the room, as well as turn the lights on or off. This is primarily because, as afore mentioned, it is aimed to treat more than one type of problem. Before using this virtual reality technology, a patient must first visit a physician or health care professional to evaluate his or her condition, diagnose, and choose the proper treatment. Therefore, in this invention, the virtual reality technology is used as a possible course of treatment, and it's personalized according to the patient's needs.

Another patent identified is US20150004591A1—“Device, system, method, and computer-readable medium for providing an educational, text-based interactive game”. It protects a method, device, system, and computer medium for implementing and/or providing an educational, text-based, interactive game. It can be used on mobile communication devices such as cellphones, tablet computer, personal digital assistants, or any device that supports short or multimedia message services. The invention refers to an interactive game that uses scheduled messages to enhance the interactive user experience and can be used for various social causes, issues and goods including teen pregnancy and bullying. However, it does not have a virtual reality element.

The present invention seeks to lower the incidence of bullying in academic environments through a training program that helps victims of bullying by means of a virtual reality environment. The “Mission: School Peace” program was developed in conjunction with psychologist and pedagogue experts and researchers from different universities and educational centers. It has been successfully used in hospitals of the Ministry of National Defense in Mexico, and belongs to the Fund of the Programs of Innovation Stimuli, through a collaboration of Tunube, and the Autonomous Metropolitan University (UAM-Universidad Autónoma Metropolitana).

### SUMMARY OF THE INVENTION

The present invention refers to a training method in virtual reality environments for bullying prevention developing coping skills and assertiveness in children. The program (6) recreates school spaces such as classrooms, where practical strategies are implemented, putting users in real-life bullying scenarios that often occur in academic environments. Three roles are considered in these situations: bullies, victims and bystanders.

The method includes a virtual reality environment with voices, music, sounds, dialogues and other forms of psycho-pedagogical stimulation. The virtual reality system requires: a specialized computer system (2), a virtual reality display (3) (head-mounted display) or other form of visual stimulation such as screens and sound system that allow the user to have a virtual reality experience, and video game controls (4). It is also possible to use physiological monitoring sensors (5), allowing the system or applicator to have a more accurate assessment as to the user's reaction. Each participant is assigned an ID number with which he or she must log in. The identification number helps keep track of their progress and maintain privacy. These files are stored in a cloud database (7), making it possible to keep track of the students' progress, review students' answers in each level and identify who is susceptible to bullying. Additionally, business intelligence and relevant statistics are generated and shared with schools and parents.

The method also consists of assessments (8) before and after the exposure of the user to the virtual reality, with the purpose of evaluating specific skills and the effectiveness of the program. The user is exposed to different bullying situations for 5 sessions of approximately 30 to 40 minutes: the first and last involve questionnaires (8) to assess specific skills before and after the participant uses the virtual reality software (6); sessions 2, 3, and 4, require the virtual reality system. During these sessions, the user is exposed to different bullying situations through a videogame-like interface, where he or she is asked behavioral questions. Three choices are displayed: a passive reaction, a violent reaction and an assertive reaction (the latter being the recommended choice). The user must choose the option that he or she relates most using the videogame control (4). The user then receives automatic feedback directly related to the chosen course of action. The program includes 1 tutorial and 12 levels, each one involving different challenges based on real-life situations that will help participants acquire specific abilities to deal with bullying situations. The software (6) can either be managed by a responsible person (e.g. psychologist or school counselor) who can follow up the sessions of the users, or autonomously.

The main advantage of using the virtual reality training method compared to traditional bullying-prevention methods is that, after completing the program, the user has developed behavioral skills to prevent and combat bullying and school harassment. This results in a favorable impact on bullying statistics, as there is a visible reduction in the number of cases.

### DETAILED DESCRIPTION OF THE INVENTION

The present invention describes a virtual reality training method for those exposed to bullying, particularly within a school environment. The main goal of the “Mission: School Peace” program is to sensitize, educate, and develop and promote skills to cope with bullying occurring in both middle school and junior high institutions. Specific objectives include: 1) learning about school environments and evaluating bullying/school harassment (both the frequency and the intention of the same); 2) sensitizing participants regarding bullying; 3) promoting and developing participants' skills in resolving harassment situations assertively; 4) identifying the factors related to bullying and its impact on the participants; and 5) determining the satisfaction of the participants when participating in this type of programs.

Three different roles are considered: the victim (the bullied), the bully (the aggressor), and the bystander (the witness). The virtual reality scenario (6) recreates classroom spaces such as classrooms and playgrounds, where users are presented in real-life school bullying situations commonly experienced by children.

The method consists of a software solution (6) that is available through a video game-like interactive program, which uses a strategic methodology consisting of different scenarios.

Additionally, the virtual reality system includes voices, music, sounds, dialogues and other forms of psycho-pedagogical stimulation. It requires several elements to carry out the training in virtual reality:
1) a specialized computer system (2), specifically, computer equipment with
   a. Processor: 3rd Generation Intel Core i5 2.5 Ghz
   b. RAM: 4 Gb
   c. Storage Space: 10 Gb
   d. Windows 8.1 or higher
   e. Connectivity: Wireless network card.
   f. Stable connection of at least 1 Mbps
   g. Mouse
   h. Headphones
Users may also require:
   i. Mousepad
   j. Current extension cables
   k. Multi-plug sockets
2) a virtual reality viewer (head-mounted display (3)) or another form of visual stimulation such as screens and sound system that allow the user to have a virtual reality experience,
3) video game controls (4).
4) It is possible to (optionally) use physiological monitoring sensors (5) such as heart rate, pressure and the galvanic response of the skin (sweating). These will allow the applicator system to have a more accurate assessment as to the user's reaction.

The software (6) includes a cloud database (7) to store participant files. Each participant is assigned an ID number with which he or she must log in. The identification number helps keep track of their progress and maintain privacy. Through this ID, it is possible to keep track of the students' progress, review students' answers in each level and identify individuals who are most susceptible to bullying (both as bullies or victims). Additionally, the software (6) generates business intelligence as well as relevant statistics that are shared with schools and parents.

The software (6) can either be managed by a responsible person (e.g. psychologist or school counselor) who can follow up the sessions of the users, or autonomously. The program consists of five sessions of approximately 30 to 40 minutes, three of which involve the use of the virtual reality software. During the first and last session (before and after the exposure of the user to the virtual reality), students are assessed by means of different questionnaires (8) with the purpose of evaluating specific skills. During the virtual reality sessions, the user is exposed to different bullying situations through a videogame-like interface, where he or she is asked behavioral questions. Three choices are displayed: a passive reaction, a violent reaction and an assertive reaction (the latter being the recommended choice). The user must choose the option that he or she relates to most with the help of the videogame control (4). The user then receives automatic feedback directly related to the chosen course of action. The virtual reality program includes 1 tutorial and 12 levels, each one involving different challenges based on real-life situations that will help participants acquire specific abilities to deal with bullying situations. The following list briefly describes the scenarios and the specific objective of each level:
1. Tutorial: the user will learn how to move and interact within the virtual reality scenario.
2. Being ignored or unable to speak: the user will reflect on the importance of avoiding people who make him or her feel “out of place”.
3. Being made fun of when a mistake is made: The user will learn that he or she should not feel guilty when he or she makes a mistake.
4. When others tell lies about the participant: The user will reflect on the best way to act when hurtful lies are being spread about him or her.
5. Being screamed or yelled at: The user will learn that in situations that involve verbal violence, it is best to try to stop it and avoid falling into violent reactions; if the aggression continues, the best thing is to involve an authority figure (a responsible adult, e.g. teachers).
6. Being mocked: The user will learn to interpret acts of imitation as part of malicious mockeries that should not be given importance.
7. Being ridiculed: The user will learn that it's best to avoid people who try to make them look ridiculous in front of others.
8. Being provoked: The user will understand that there are situations that can be embarrassing. However, these situations are often accidents, and therefore there is no need to feel embarrassed.
9. When stuff is stolen or hidden from the participant: The user will learn to express their problems with an authority figure.
10. Being hit or punched: The user will be able to give solutions that mediate the problem and avoid violent situations.
11. Being pinched or scratched: The user will demand respect through a series of arguments that strengthen his or her ability to deal with the aggressor.
12. When someone pulls the user's hair: The user will analyze his or her behavior in front of the aggressor so that the situation is not repeated.
13. Being pushed or pulled (e.g. tossed to a garbage can): The user will put an end to any type of aggression and, if necessary, will go to the authority.

The method was developed in conjunction with psychologist and pedagogue experts and is aligned with “Construye T”, a program created by the Mexican Government. It was designed and implemented through the Secretariat of Education, in collaboration with the United Nations Development Program (UNDP), whose objective is to develop social-emotional skills in students, and thus improve the school environment.

The execution of the “Mission: School Peace” program takes 5 sessions, and involves the following procedure:

Session 1 (Pre-test): Students must answer a series of questionnaires regarding the school environment and factors that contribute to bullying. (1) (6) (7) (8)
Session 2: Involves the first test, and the use of the virtual reality system for the application of scenarios 1-5. (1) (6) (7)
Session 3: Uses the virtual reality system for the application of scenarios 6-9. (1) (6) (7)
Session 4: Uses the virtual reality system for the application of scenarios 10-13. (1) (6) (7)
Session 5 (Post-test): This must be a week after the application of the training program. Students must answer the questionnaires they did on session 1 to help evaluate the skills they have developed. (1) (6) (7) (8)

This method has been successfully implemented at a technical high school in Mexico, where 47 first grade students participated. Participants obtained positive results specifically regarding the application of assertive behaviors and the reduction of aggressive behaviors. The results indicate that a valid and reliable instrument was obtained for Mexican children; it allows a more detailed assessment of school harassment situations, which will in turn lead to a decrease in the amount of bullying cases.

### BRIEF DESCRIPTION OF THE DRAWINGS

FIG. 1. Is a block diagram of a virtual reality computer system employed in the bullying prevention method, according to the invention.

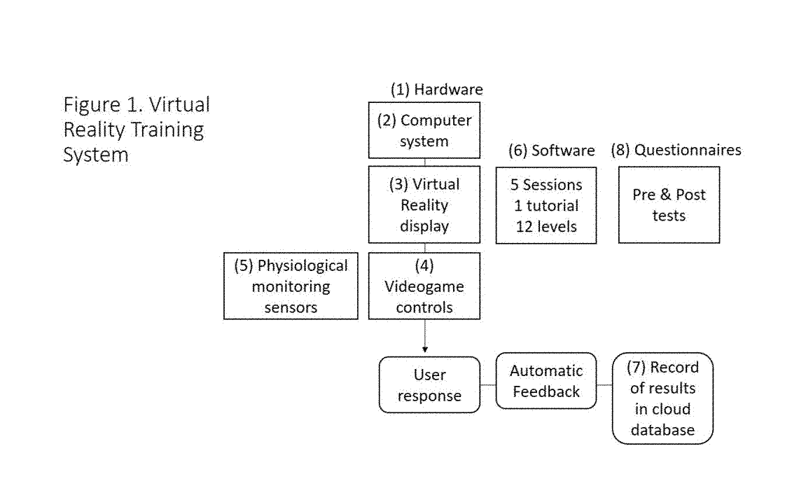

FIG. 2. Is a flowchart illustrating the implementation method of the virtual environment training system.

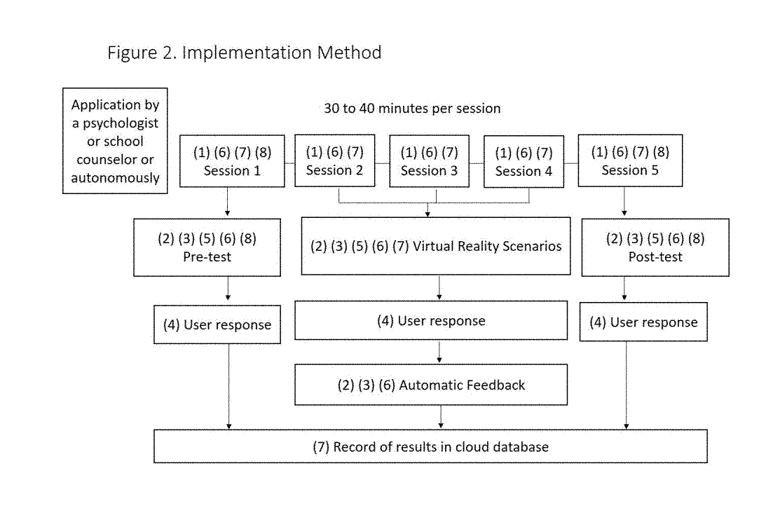

FIG. 3. Is a diagram detailing the activities carried out each session of this training method.

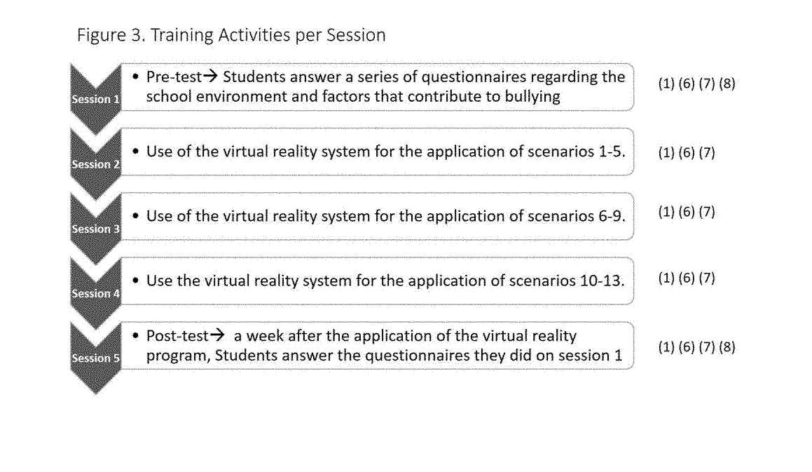

FIG. 4. Is a block diagram presenting the scenarios shown to participants in each level of the training method.

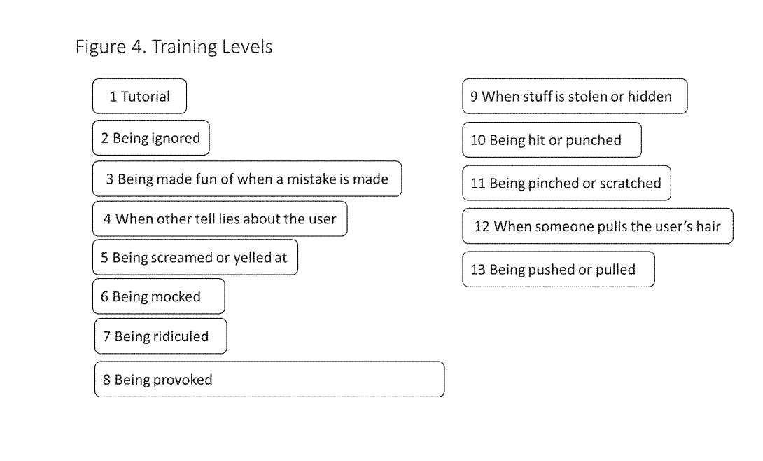

FIG. 5. Is a block diagram showing how a virtual environment is used to train participants and prevent bullying, as well as how participants' answers are registered within the cloud database.

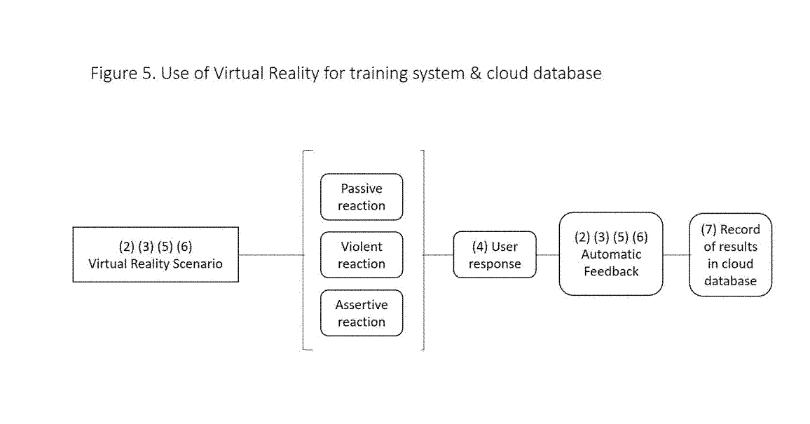

### REFERENCE NUMERALS

1. Hardware (includes 2, 3, 4, 5)
2. Computer
3. Head-mounted display
4. Videogame Controls
5. Physiological Monitor Sensors
6. Software
7. Cloud Database
8. Pre- & Post-test Questionnaires

What is claimed is:

1) A training method with virtual reality technology for school harassment prevention, to be used particularly in school environments, as it is focused on preventing bullying in students of both middle school and junior high.

2) The method of claim 1, comprising a software solution that is available through a video game-like interactive program; the method particularly seeks to:
a. learn about school environments and evaluating bullying/school harassment (both the frequency and the intention of the same);
b. sensitize participants regarding bullying;
c. promote and develop participants' skills in resolving harassment situations assertively;
d. identify the factors related to bullying and its impact on the participants; and
e. determine the satisfaction of the participants when participating in this type of programs.

3) The method of claim 1, comprising a tutorial and 12 levels, each one involving different challenges based on real-life situations that will help participants acquire specific abilities to deal with bullying situations.

4) The method of claim 1, wherein said method lowers the incidence of bullying in academic environments, by recreating classroom spaces such as classrooms and playgrounds, where strategies are implemented for all users in real school bullying situations experienced by children, comprising:
a. Five sessions lasting 30 to 40 minutes.
b. Assessments (questionnaires) before and after the exposure of the user to the virtual reality program.
c. Scenarios based on real-life situations that consider three roles involved in bullying situations: bullies, victims and bystanders.
d. Behavioral questions regarding said scenarios, where the user must choose the option that he or she relates to most.
e. The automatic provision of feedback directly related to the chosen course of action.

5) The method of claim 1, comprising forms of psycho-pedagogical stimulation, including but not limited to voices, music, sounds and dialogues.

6) The method of claim 1, comprising 5 sessions involving the following protocol:
a. Session 1 (Pre-test): Students must answer a series of questionnaires regarding the school environment and factors that contribute to bullying.
b. Session 2: Involves the first test, and the use of the virtual reality system for the application of scenarios 1-5.
c. Session 3: Uses the virtual reality system for the application of scenarios 6-9.
d. Session 4: Uses the virtual reality system for the application of scenarios 10-13.
e. Session 5 (Post-test): applied a week after the implementation of the virtual reality training program. Students must answer the same questionnaires they did on session 1 to help evaluate the skills they have developed.

7) The method of claim 1, including a software which assigns an ID number and a file to each participant, saving them in a cloud database, comprising the steps of:
a. Assigning and saving a file per participant in the cloud database,
b. Keeping track of each students' progress while maintaining privacy,
c. Reviewing students' answers in each level and identify who is susceptible to bullying,
d. Generating relevant statistics and business intelligence.

8) The method of claim 1, wherein said method can be implemented by a responsible person who can follow up the sessions of the users and the software used in the method can run autonomously.

9) The method of claim 1, comprising the following elements:
a. a specialized computer system, specifically, computer equipment with
i. Processor: 3rd Generation Intel Core i5 2.5 Ghz
ii. RAM: 4 Gb
iii. Storage Space: 10 Gb
iv. Windows 8.1 or higher
v. Connectivity: Wireless network card.
vi. Stable connection of at least 1 Mbps
vii. Mouse
viii. Headphones
Wherein users may also require:
ix. Mousepad
x. Current extension cables
xi. Multi-plug sockets
b. a virtual reality viewer (head-mounted display) or another form of visual stimulation such as screens and sound system that allow the user to have a virtual reality experience,
c. Video game controls.

10) The method of claim 1, comprising physiological monitoring sensors such as heart rate, pressure and the galvanic response of the skin (sweating).

11) The method of claim 1, wherein said method has the advantage of using the virtual reality training method described in previous claims, compared to traditional bullying-prevention methods, is that the user develops behavioral skills to prevent and combat bullying and school harassment.
